(19) United States
(12) Patent Application Publication
(10) Pub. No.: US 2018/0106099 A1
(43) Pub. Date: Apr. 19, 2018

(54) Window Cover Apparatus

(71) Applicants: Joanie McVey, Staten Island, NY (US); Carolyn Santo, Staten Islnad, NY (US)

(72) Inventors: Joanie McVey, Staten Island, NY (US); Carolyn Santo, Staten Islnad, NY (US)

(21) Appl. No.: 15/297,921

(22) Filed: Oct. 19, 2016

(51) Int. Cl. E06B 9/262; E06B 9/24; E06B 3/30; E06B 3/70; E06B 9/38

(52) U.S. Cl. CPC E06B 9/262; E06B 9/24; E06B 3/30; E06B 2009/2625; E06B 9/38; E06B 2009/2622; E06B 3/7001

(57) ABSTRACT

A window cover apparatus for covering a window is provided. The window has a window opening and a window frame surrounding the window opening. The window cover apparatus comprises a shade qovering having a front side, a rear side, a top edge, a bottom edge, a first side edge, and a second side edge. An adhesive strip is mounted nearingly adjacent the top edge on the rear side of the shade covering. The shade covering is constructed from a paper material covered with a first pattern. The shade covering is capable of being secured over at least a portion of the window opening.

### CLAIM OF PRIORITY

This patent application claims priority under 35 USC 119 (e) (1) from U.S. Provisional Patent Application Ser. No. 62/099,928 filed Jan. 5, 2015, of common inventorship herewith entitled, “Design A Shade,” which is incorporated herein by reference as though the same were set forth in its entirety.

### FIELD OF THE INVENTION

The present invention pertains to the field of window coverings, and more specifically to the field of window coverings constructed from customizable paper shades.

Design-A-Shade is a line of temporary decorative paper window shades that simply adhere to window frames (no hardware). The invention provides an inexpensive, attractive, temporary window covering solution.

### BACKGROUND OF THE INVENTION

Design-A-Shade offers consumers an attractive and affordable means of decorating their windows. Peel & stick design embellished with colorful patterns, this versatile product lends a stylish air to any room. Design-A-Shade appeals to virtually any taste while also extremely affordable. Whether a grandmother on a fixed income or a college student moving into a dorm room, consumers would be able to line every window at a mere fraction of the cost of custom window treatments, without the need for complicated hardware or marring window frames with screws and brackets.

Design-A-Shade is fabricated in durable paper material. It is offered in various sizes including 48″×72″. In addition, a 60″×84″ size is produced for sliding glass doors. Each shade includes 2 coordinating clips. Design-A-Shade is available in two styles. One as a Roman shade and one as an Accordion shade. Each pattern can also be made into a valance with a solid colored one to allow the consumer to mix and match to create his or her own unique look. The color story and pattern is versatile enough to be used in any room. The Design-A-Shade offers the ultimate combination of convenience, privacy and style for their homes.

Nothing compares to the comforts of home when looking for a respite from the constant demands of daily living. When busy days are done, walking into one's own personally decorated sanctuary can foster a feeling of well-being and comfort. While many people want their homes to reflect exquisite style, they also desire a casual tone that is inviting to them as well as to their guests. Professional interior designers provide many suggestions to achieve these effects including using bright colors to liven the atmosphere, adding vintage sconces to create a relaxing ambiance and hanging artwork, prints and posters to inject character.

Many people use various window treatments to accentuate their living spaces. Whether fashioning windows with plush flowing curtains topped with an ornate valance or simply adorning them with serviceable drapes, window decoration often proves to be an integral part of creating an atmosphere of style, serenity and solace. Both decorative and functional, horizontal and vertical blinds and shades are particularly popular because they offer a simple and attractive way to filter light and ensure privacy. Whether white or cream colored blinds and shades made of plastic or darker heavy duty blind and shades fashioned of wood products, these standard window coverings are found in millions of homes across America.

The prior art has put forth several designs for customizable shades. Among these are:

U.S. Pat. No. 7,665,500 to Alejandro Rossato, Amrik Singh and Cliff Burch describes a temporary window shade that includes an elongated cover having a top end and a bottom end, and that is adaptable to be oriented in a retracted position, an extended position and a plurality of intermediate positions. The temporary window shade includes a top rail that is attachable to the top end of the elongated cover, a cord having a first end that is connectable to the top rail, and a bottom rail that is attachable to the bottom end of the elongated cover. The bottom rail has a slot disposed through a surface of the bottom rail, and the slot is adaptable to receive the cord. At least a portion of the slot has a width less than the thickness of the cord such that the slot engages the cord to support the weight of the bottom rail and an accumulated portion of the elongated cover when the cord is engaged by the at least a portion of the slot.

U.S. Pat. No. 5,158,127 to Donald W. Schumacher describes a temporary covering for a window or the like, including an elongated paper like sheet having equidistant parallel pleats defined by creases extending across the sheet. An adhesive fastening strip is located at the top end of the sheet for fastening the sheet to a window, window frame or the like. When mounted to window or window frame, the temporary window covering extends downwardly to a selected variable length, while maintaining a pleated appearance.

US Patent 2004/0226661 to Hsin-Yun Su describes a temporary shade for a window including an elongated sheet with a top end, a bottom end, a plurality of equal space and parallel pleats. The pleat extends from the top end to the bottom end. The pleat has two banks of parallel via holes. A locking device is installed to the bottom end of the sheet for adjusting the length of the sheet. The locking device has a supporting element and a stop element. The supporting element has a first end and a second end. The first end is formed as a plane bottom which is unable to pass through the holes of the pleat. The stop element is combined to the supporting element. The pleat is positionable between the plane bottom and the stop element for sustaining sheet in a desired length.

None of these prior art references describe the present invention.

### SUMMARY OF THE INVENTION

It is an object of the present invention to provide a line of patterned and colorful paper window coverings that are easily and safely adhered to a window frame to provide an instant means of turning any room into a showplace.

The present invention is a window cover apparatus for covering a window. The window has a window opening and a window frame surrounding the window opening. The window cover apparatus comprises a shade covering having a front side, a rear side, a top edge, a bottom edge, a first side edge, and a second side edge. An adhesive strip is positioned nearingly adjacent the top edge on the rear side of the shade covering. The shade covering is constructed from a paper material covered with a first pattern. The shade covering is capable of being secured over at least a portion of the window opening.

In addition, the present invention is a method for covering a window. The window having a window opening and a window frame surrounding the window opening. The method comprises providing a shade covering having a front side, a rear side, a top edge, a bottom edge, a first side edge, and a second side edge, mounting an adhesive strip nearingly adjacent the top edge on the rear side of the shade covering, constructing the shade covering from a paper material covered with a pattern, and securing the shade covering over at least a portion of the window opening.

The present invention further includes a window cover apparatus for covering a window. The window has a window opening and a window frame surrounding the window opening. The window cover apparatus comprises a shade covering having a front side, a rear side, a top edge, a bottom edge, a first side edge, and a second side edge. An adhesive strip is positioned nearingly adjacent the top edge on the rear side of the shade covering. At least one clip is mounted to the shade covering. A valance is mountable across the top edge of the shade covering. The shade covering is constructed from a paper material covered with a first pattern and the valance is constructed from a paper material covered with a second pattern.

The shade covering is capable of being secured over at least a portion of the window opening.

### BRIEF DESCRIPTION OF THE DRAWINGS

FIG. 1 is a front elevational view illustrating a shade of a window cover apparatus of the present invention including peel and stick, folding, adhesives, and decorative clips.

FIG. 2 is a front elevational view illustrating another embodiment of the shade of the window cover apparatus of the present invention including peel and stick, folding, adhesives, and decorative clips.

FIG. 3 is a front elevational view illustrating still another embodiment of the shade of the window cover apparatus of the present invention including peel and stick, folding, adhesives, decorative clips, and a valence.

FIG. 4 is a front elevational view illustrating still yet another embodiment of the shade of the window cover apparatus of the present invention including peel and stick, folding, adhesives, decorative clips, and a valence.

FIG. 5 is a front elevational view of a valance of the window cover apparatus of the present invention.

FIG. 6 is a front elevational view of another embodiment of the valance of the window cover apparatus of the present invention.

FIG. 7 is a front elevational view of still another embodiment of the valance of the window cover apparatus of the present invention.

FIG. 8 is a front elevational view of still yet another embodiment of the valance of the window cover apparatus of the present invention

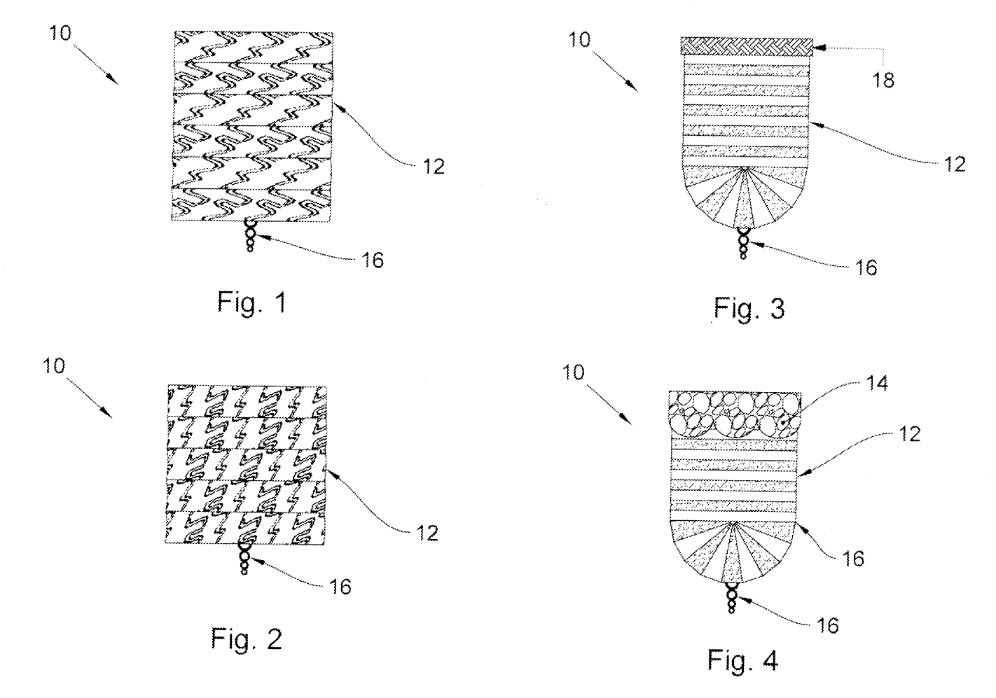

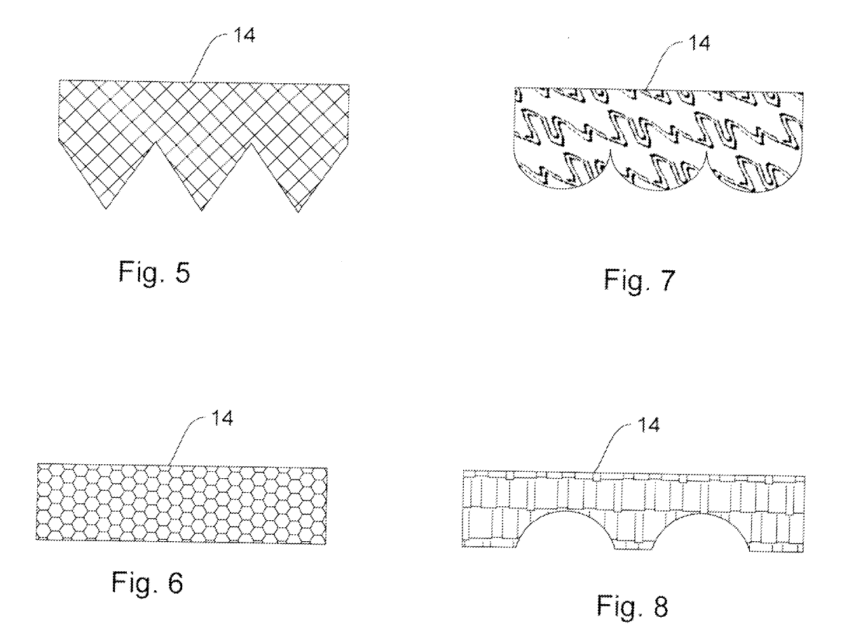

### DETAILED DESCRIPTION OF THE INVENTION

The present invention, hereinafter referred to as a Window Cover Apparatus, indicated generally at 10, is a line of patterned and colorful paper shade coverings 12 and valances 14 that are easily and safely adhered to a window frame to provide an instant means of turning any room into a showplace. Fabricated of a durable paper material, the shade covering 12 of the Window Cover Apparatus 10 is constructed in various sizes including, but not limited to, approximately forty eight inches in width by seventy two inches in length and thirty six inches in width and seventy two inches in length.

It should be noted that the shade covering 12 of the Window

Cover Apparatus 10 of the present invention can be sized to accommodate covering a sliding glass door in a larger size that measures approximately sixty inches in width by eighty four inches in length. The shade covering 12 also can be cut by a user to perfectly match their window frames. The shade covering 12 of the Window Cover Apparatus 10 accommodates virtually any household window from small bathroom windows to large picture windows.

Each Window Cover Apparatus 10 of the present invention contains at least one, but preferably approximately two, coordinating clips 16 along with additional decorative clips 16 and coordinating valances 14. Each shade covering 12 of the Window Cover Apparatus 10 sheet contains a strip of durable adhesive material 18 along a top edge on the rear side of the shade covering 12 for installation. This adhesive material 18 is preferably protected by a peel away strip until the shade covering 12 is ready to be installed over or in a window.

The Window Cover Apparatus 10 of the present invention can be constructed in at least two embodiments. One embodiment is a Roman shade covering format and the second embodiment is an Accordion shade covering format. Each available pattern fabrication is also made into a valance 14. Along with available solid colored shade coverings 12 and valances 14, a user can mix and match their shade coverings 12 and valances 14 to create their unique decor. Preferably, the shade covering 12 is constructed from a paper material covered with a first pattern and the valance 14 is constructed from a paper material covered with a second pattern with the second pattern of the valance 14 coordinating with the first pattern on the shade covering 12. In the present application, coordinating is defined as the designs and/or colors of the shade covering 12 and the valance 14 being related, blended, or matched to a particular design and/or color scheme. In an embodiment, the first pattern of the shade covering 12 is actually identical to the second pattern of the valance 14 such that the design and/or color of both the shade covering 12 and the valance 14 match.

The Window Cover Apparatus 10 of the present invention is manufactured in color palates and patterns that are versatile enough to be used in any room such as kitchen, dining room, family room, bedroom or bath. Unique patterns and styles are manufactured on a seasonal basis.

Using the Window Cover Apparatus 10 of the present invention is very simple and straightforward. A user determines what size shade coverings 12 are needed by measuring each window area to be covered. Once the correct size is ascertained, the user then chooses a Window Cover Apparatus 10 based on personal preference of style, color, and the room in which it is installed. A family may select a sleek sheet of faux wood verticals featuring a family photograph to accentuate the decorative motif of their living room. A homemaker may select a Window Cover Apparatus 10 that depicts foods and vegetables to cover the windows in the kitchen. The user cuts the shade covering 12 and/or the valance 14 of the Window Cover Apparatus 10 to size if necessary, then peels away the paper from the adhesive portion and firmly presses the shade covering 12 along the window frame. Left in place indefinitely, the Window Cover Apparatus 10 is exchangable whenever desired.

The Window Cover Apparatus 10 provides individuals on constricted budgets with an extremely affordable option for adding flair to their living spaces. Users can easily line every window with a Window Cover Apparatus 10 without the need for complicated hardware or marring window frames with screws and brackets. The Window Cover Apparatus 10 is highly functional in residential homes as well as businesses to decorate their offices or serve as a means of advertisement. The Window Cover Apparatus 10 is useful in temporary situations such as a college dorm room, for example. Another useful application of the Window Cover Apparatus 10 is for staging a house on the market for showing to prospective buyers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A window cover apparatus for covering a window, the window having a window opening and a window frame surrounding the window opening, the window cover apparatus comprising:
a shade covering having a front side, a rear side, a top edge, a bottom edge, a first side edge, and a second side edge; and
an adhesive strip positioned nearingly adjacent the top edge on the rear side of the shade covering;
wherein the shade covering is constructed from a paper material covered with a first pattern; and
wherein the shade covering is capable of being secured over at least a portion of the window opening.

2. The window cover apparatus of claim 1 wherein the shade covering is capable of being secured to the window frame.

3. The window cover apparatus of claim 1 wherein the shade covering covers the entire window opening.

4. The window cover apparatus and further comprising:
a line of patterned paper shade coverings.

5. The window cover apparatus of claim 1 wherein the shade covering is constructed in various sizes.

6. The window cover apparatus of claim 1 wherein the window opening is a sliding glass door and shade covering is sized and shaped for completely covering the sliding glass door.

7. The window cover apparatus of claim 1 wherein the size of the shade covering is conformable to a particular window size by cutting the shade covering to fit.

8. The window cover apparatus of claim 1 and further comprising:
at least one clip mounted to the shade covering.

9. The window cover apparatus of claim 1 and further comprising:
a valance mountable across the top edge of the shade covering;
wherein the valance is constructed from a paper material covered with a second pattern; and
wherein the second pattern of the valance coordinates with the first pattern on the shade covering.

10. The window cover apparatus of claim 9 wherein the first pattern of the shade covering is identical to the second pattern of the valance.

11. The window cover apparatus of claim 1 wherein the adhesive strip is covered by a removable peel away strip.

12. The window cover apparatus of claim 1 wherein the adhesive strip releasably secures the shade covering over at least a portion of the window opening.

13. The window covering apparatus of claim 1 wherein the shade covering is selected from the group consisting of a Roman shade and an Accordion shade.

14. A method for covering a window, the window having a window opening and a window frame surrounding the window opening, the method comprising:
providing a shade covering having a front side, a rear side, a top edge, a bottom edge, a first side edge, and a second side edge;
mounting an adhesive strip nearingly adjacent the top edge on the rear side of the shade covering;
constructing the shade covering from a paper material covered with a pattern; and
securing the shade covering over at least a portion of the window opening.

15. A window cover apparatus for covering a window, the window having a window opening and a window frame surrounding the window opening, the window cover apparatus comprising:
a shade covering having a front side, a rear side, a top edge, a bottom edge, a first side edge, and a second side edge;
an adhesive strip positioned nearingly adjacent the top edge on the rear side of the shade covering;
at least one clip mounted to the shade covering; and
a valance mountable across the top edge of the shade covering;
wherein the shade covering is constructed from a paper material covered with a first pattern;
wherein the valance is constructed from a paper material covered with a second pattern;
wherein the shade covering is capable of being secured over at least a portion of the window opening.

16. The window cover apparatus of claim 15 wherein the second pattern of the valance coordinates with the first pattern of the shade covering.

17. The window cover apparatus of claim 15 wherein the shade covering is constructed in various sizes.

18. The window cover apparatus of claim 15 wherein the first pattern of the shade covering is identical to the second pattern of the valance.

19. The window cover apparatus of claim 15 wherein the adhesive strip is covered by a removable peel away strip.

20. The window covering apparatus of claim 15 wherein the shade covering is selected from the group consisting of a Roman shade and an Accordion shade.
